(19) United States
(12) Patent Application Publication
(10) Pub. No.: US 2008/0245197 A1
(43) Pub. Date: Oct. 9, 2008

(54) SYSTEM AND METHOD FOR DAMPENING VIBRATION OF A TOOL

(75) Inventors: BRIAN J. MARTINEK, TROY, MO (US); JAMES A. HAMMOND, O'FALLON, MO (US); RALPH D. CZESCHIN, WASHINGTON, MO (US)

Correspondence Address: WILDMAN HARROLD ALLEN & DIXON LLP;AND THE BOEING COMPANY, 225 W. WACKER DR., CHICAGO, IL, 60606, US

(73) Assignee: THE BOEING COMPANY, CHICAGO, IL (US)

(21) Appl. No.: 11/696,078

(22) Filed: Apr. 3, 2007

(51) Int. Cl. B25G 1/01

(52) U.S. Cl. 81/489; 173/162.2; 267/137

(57) ABSTRACT

Apparatus and methods for dampening vibration of a tool are provided. In one embodiment, a handle portion of a vibrating tool is inserted into a cavity of left and right side parts of a grip which is at least one of made of and lined with a vibration dampening material. The handle portion may be wrapped with a second vibration dampening material prior to being inserted within the grip. The casting of the handle portion of the vibrating tool may be reduced in order to avoid a size increase of the tool when the handle is enclosed within the cavity of the grip. In such manner, the tool may be more ergonomically feasible.

### BACKGROUND OF THE INVENTION

A variety of apparatus and methods exist today for the dampening of vibration which is transferred from a tool to a user's hand. For instance, one existing method is to wrap the outside of the handle of a vibrating tool with tape in order to dampen the vibration of the tool. However, this may lead to an unduly increase in size of the tool, poor dampening of vibration, safety risks, increased difficulty in handling the tool, ergonomic difficulties, and/or one or more other types of problems.

An apparatus and/or method for dampening vibration of a tool is needed to decrease one or more problems associated with one or more of the existing apparatus and/or methods.

### SUMMARY OF THE INVENTION

In one aspect of the invention, a method for dampening vibration of a tool handle is provided. In one step, a grip is provided which is at least one of made of and lined with a vibration dampening material. The grip has an internal cavity. In another step, at least a portion of a handle of a tool which vibrates is inserted into the internal cavity of the grip.

In another aspect of the invention, an apparatus for dampening vibration of a tool comprises a grip which is at least one of made of and lined with a vibration dampening material, wherein the grip has an internal cavity which is adapted to enclose a handle portion of a vibrating tool.

In a further aspect of the invention, a vibrating tool comprises a handle portion which is substantially enclosed within an internal cavity of a grip which is at least one of made of and lined with a vibration dampening material.

These and other features, aspects and advantages of the invention will become better understood with reference to the following drawings, description and claims.

### BRIEF DESCRIPTION OF THE DRAWINGS

FIG. 1 shows a perspective view of one embodiment of a vibration dampening apparatus attached to a vibrating tool;

FIG. 2 shows a partially unassembled perspective view of the vibration dampening apparatus of FIG. 1 with respect to the vibrating tool;

FIG. 3 shows a perspective view of another embodiment of a reduced sized vibration dampening apparatus attached to a vibrating tool;

FIG. 4 shows a partially unassembled perspective view of the reduced sized vibration dampening apparatus of FIG. 3 with respect to the vibrating tool;

FIG. 5 shows a perspective view of an embodiment of a right angled vibration dampening apparatus attached to a right angled vibrating tool;

FIG. 6 shows a partially unassembled perspective view of the right angled vibration dampening apparatus of FIG. 5 with respect to the right angled vibrating tool; and

FIG. 7 is a flowchart depicting an embodiment of a method for dampening vibration of a tool handle.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

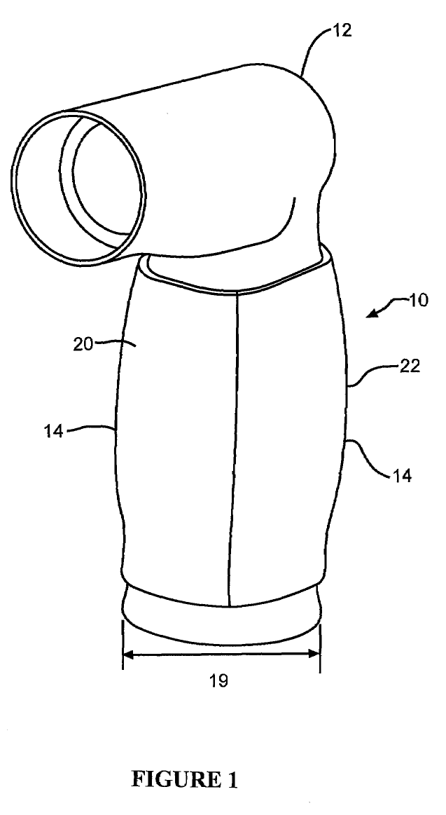

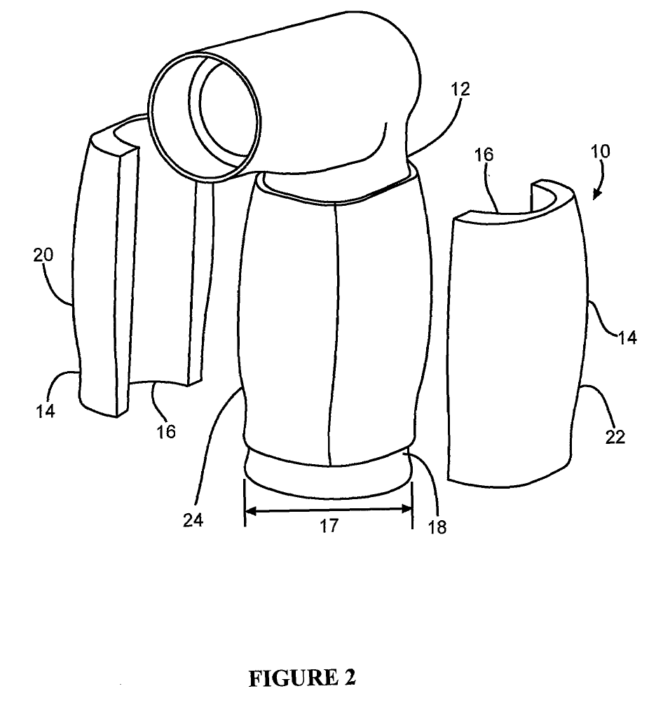

FIG. 1 depicts a perspective view of one embodiment of an apparatus 10, for the dampening of vibration, attached to a vibrating tool 12. The tool 12 may comprise an electric hand-held tool, a pneumatic hand-held tool, or other type of vibrating tool 12. As shown in FIG. 2, which is a partially unassembled perspective view of the apparatus 10 of FIG. 1, the apparatus 10 may comprise a substantially linear, circular grip 14 which is defined by an internal cavity 16 which is adapted to enclose a handle portion 18 of the vibrating tool 12. In other embodiments, the internal cavity 16 of the grip 14 may be configured and adapted to enclose substantially the entire tool 12, or other parts of the tool 12. The grip 14 may include a separate left side part 20 and a separate right side part 22 which are adapted to be attached to one another after the handle portion 18 of the tool 12 is inserted within the cavity 16. The left and right side parts 20 and 22 of the grip 14 may be adapted to be attached to one another using snap fits, bolts, or other attachment mechanisms known in the art. In such manner, the handle portion 18 of the tool 12 may be securely enclosed within the internal cavity 16 of the left and right side parts 20 and 22 of the grip 14, as shown in FIG. 1. The grip 14, including its left and right side parts 20 and 22, may be made of a vibration dampening material and/or one or more portions of the grip 14, such as the cavity 16 or other portion of the grip 14, may be lined with a vibration dampening material, in order to dampen the transfer of vibration from the tool 12 to a user's hand. In one embodiment, the grip may be made of plastic, and the cavity 16 of the grip may be lined with viscolas, sorbothane, or other type of vibration dampening material. In other embodiments, the grip 14 may be lined with or made of any type of vibration dampening material. In still other embodiments, the grip 14 may include any number of parts, and may be of any size, shape, or configuration. The grip 14 may be made of a material which is substantially hard to allow for easy gripping of the grip 14, while at the same time dampening the transfer of vibration to a user's hand.

As shown in FIG. 2, the handle portion 18 of the tool 12 may be wrapped with a second dampening material 24, which may also be enclosed within the cavity 16 of the grip 14 when the handle portion 18 of the tool 12 is inserted within the cavity 16 as depicted in FIG. 1. The second dampening material 24 may be made of one or more of viscolas, sorbothane, or other type of vibration dampening material. The grip 14 and its cavity 16 may be sized to closely fit around the handle portion 18 of the tool 12. In another embodiment, the handle portion 18 of the tool 12 may be inserted directly into the cavity 16 of the grip 14 without wrapping the handle portion 18 with a second dampening material 24. The grip 14 may be attached to the tool 12 during the initial manufacturing process of the tool 12. In another embodiment, the grip 14 may be adapted to be retrofitted to a handle portion 18 of a vibrating tool 12 in order to dampen vibration to a user's hand.

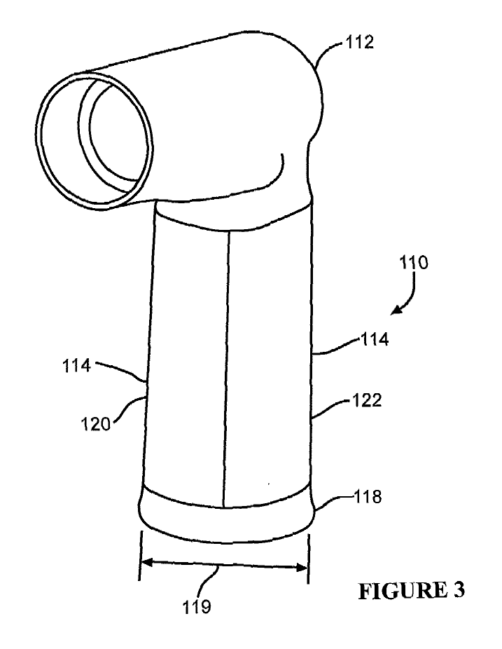

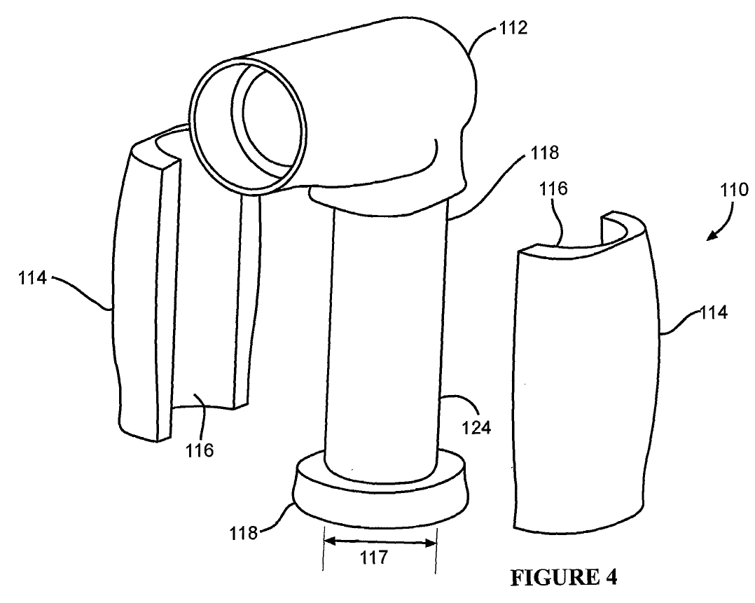

FIG. 3 depicts a perspective view of another embodiment of an apparatus 110, for the dampening of vibration, attached to a vibrating tool 112. FIG. 4 shows a partially unassembled perspective view of the apparatus 110 of FIG. 3. As in the embodiment of FIGS. 1 and 2, the apparatus 110 of FIGS. 3 and 4 comprises a substantially linear, circular grip 114, comprising attachable left and right side parts 120 and 122 which may be made of or lined with vibration dampening material, which is defined by an internal cavity 116 which is adapted to enclose a handle portion 118 of a vibrating tool 112 wrapped in a second dampening material 124 in order to dampen the transfer of vibration to a user's hand. However, the width 17 of the casting of the handle portion 18 of the vibrating tool 12 of FIGS. 1 and 2 was reduced in size in order to produce the smaller width 117 of the handle portion 118 of the vibrating tool 112 of FIGS. 3 and 4. Similarly, the width 19 of the casting of the grip 14 of FIGS. 1 and 2 was reduced in size in order to produce the smaller width 119 of the grip 114 of FIGS. 3 and 4. The reduction in size allows for the grip 114 of FIGS. 3 and 4 to have an overall size which is the same size or smaller than the casting of the handle portion 18 of the original vibrating tool 12. This may allow for ergonomic advantages in ease of use and gripping of the tool 112 because the transfer of vibration from the tool to a user's hand may be dampened while maintaining the same overall handle size of the tool 112. In other embodiments, the handle portion 118 may be reduced in size, but the width 119 of the grip 114 may still be larger than the width of the handle size of the original tool casting. In still other embodiments, the handle portion 118 of the tool 112 may be inserted directly into the cavity 116 of the grip 114 without wrapping the tool 112 with a second dampening material 124.

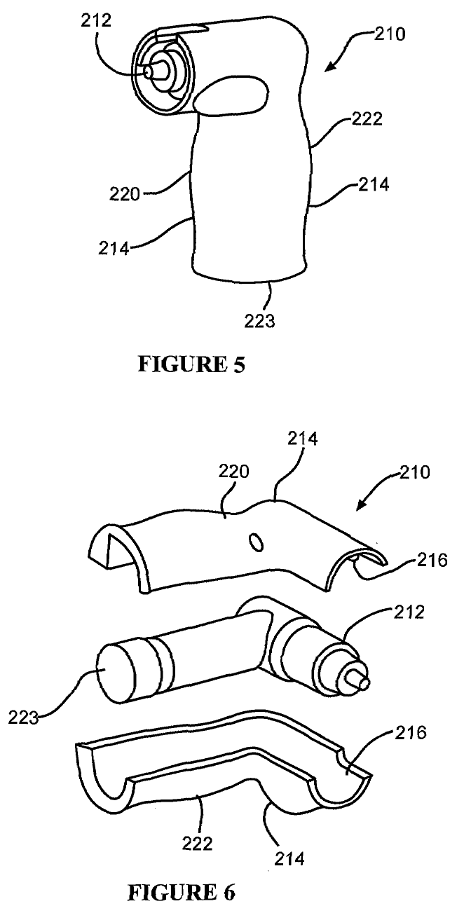

FIG. 5 depicts a perspective view of another embodiment of an apparatus 210, for the dampening of vibration, attached to a vibrating tool 212. FIG. 6 shows a partially unassembled perspective view of the apparatus 210 of FIG. 5. The apparatus 210 of FIGS. 4 and 5 comprises a right angled grip 214, comprising attachable left and right side parts 220 and 222 which may be made of or lined with vibration dampening material, which is defined by an internal cavity 216 which is adapted to substantially enclose the entire right angled vibrating tool 212. Although the tool 212 is not wrapped in a second dampening material in the embodiment shown in FIGS. 5 and 6, in other embodiments, the tool 212 may be wrapped in a second dampening material and the entire wrapped tool 212 may be enclosed within the internal cavity 216 of the right angled grip 214. The grip 214 may be attached to the tool 212 during the initial manufacturing process of the tool 212. In another embodiment, the grip 214 may be adapted to be retrofitted to a handle portion 218 of a vibrating tool 212 in order to dampen vibration to a user's hand. A motor (not shown) of the vibrating tool 212 may be attached to a bottom portion 223 of the handle portion 218 of the tool 212.

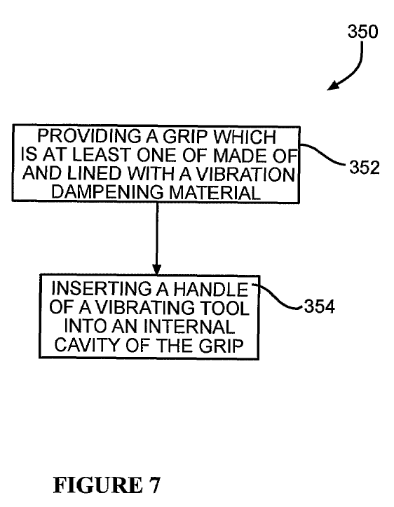

FIG. 7 depicts one embodiment of a method 350 for dampening vibration of a tool handle. In one step 352, a grip may be provided which is at least one of made of and lined with made of a vibration dampening material. The grip, which may be a right angled grip, linear grip, or other type of grip, may include an internal cavity, which may be sized to fit snugly over a handle of a vibrating tool. In another step 354, at least a portion of a handle of a vibrating tool may be inserted into the internal cavity of the grip. This may be done by attaching left and right side parts of the grip around the handle. In another embodiment, substantially the entire tool, which may be a right angle tool or other type of tool, may be inserted into the grip. In still another embodiment, at least a handle portion of the tool may be wrapped with a second vibration dampening material prior to inserting the handle into the internal cavity of the grip. In yet another embodiment, a size of a casting of an original tool may have been reduced to form the tool, the grip may have been sized to fit over the reduced sized tool, the sized grip may be the same size or smaller than a handle of the original tool, and/or at least a portion of the handle of the reduced sized tool may be wrapped with a second vibration dampening material prior to inserting the reduced sized handle into the internal cavity of the sized grip. In still other embodiments, the inserting step may comprise retrofitting a tool handle with the grip, or attaching the grip to the tool handle during the initial manufacturing process. In an additional step, a motor may be attached to a portion of the tool handle.

The disclosed apparatus and/or methods may reduce one or more problems associated with one or more of the prior art apparatus and/or methods. For instance, one or more embodiments of the apparatus and/or methods herein disclosed may provide dampening of the transfer of vibration to a user's handle while substantially keeping the profile of the tool to a manageable size, may provide improved dampening of vibration, may reduce cost, may increase safety, may be more ergonomically feasible, and/or may reduce one or more other types of problems associated with one or more of the prior art apparatus and/or methods.

It should be understood, of course, that the foregoing relates to exemplary embodiments of the invention and that modifications may be made without departing from the spirit and scope of the invention as set forth in the following claims.

1. A method for retro-fitting a tool handle of a pre-existing, vibrating, hand-held, tool in order to dampen vibration and to make the tool more ergonomically useable comprising:
providing a pre-existing, vibrating, hand-held tool wherein the tool is electric or pneumatic:
providing a grip comprising detachable and attachable left and rights grip sides wherein each of the left and right grip sides is at least one of made of and lined with a vibration dampening material, and wherein said left and right grip sides collectively form an internal cavity when attached together; and
retro-fitting a tool handle of the pre-existing. vibrating, hand-held tool in order to dampen vibration and make the tool more ergonomically useable by positioning at least a portion of the tool handle between the left and right grip sides and attaching the left and right grip sides together to secure the tool handle within the internal cavity of the left and right grip sides.

2. (canceled)

3. (canceled)

4. The method of claim 1 wherein said internal cavity is sized to fit said handle.

5. The method of claim 1 wherein the retro-fitting step comprises inserting substantially the entire tool within the internal cavity of the left and fight sides of the grip.

6. The method of claim 1 further comprising the step of wrapping at least a portion of the handle of the tool with a second vibration dampening material prior to positioning said wrapped portion of said handle within said internal cavity of the left and fight sides of the grip.

7. (canceled)

8. The method of claim 1 wherein no other vibration dampening material is used other than said grip.

9. (canceled)

10. The method of claim 1 further comprising the step of a size of a casting of an original, non-retrofitted tool being reduced to form said provided pre-existing vibrating tool.

11. The method of claim 10 further comprising the step of said provided grip being sized to fit over said reduced sized, pre-existing vibrating tool.

12. The method of claim 11 further comprising the step of said sized grip being sized to be at least one of the same size and smaller than a handle of said original, non-retrofitted tool.

13. The method of claim 12 further comprising the step of wrapping at least a portion of the handle of the tool with a second vibration dampening material prior to positioning said wrapped portion of said handle within said internal cavity of the left and fight sides of the sized grip.

14. The method of claim 1 wherein said pre-existing vibrating tool is a right angle tool, and said grip is a right angle grip.

15. The method of claim 1 wherein a motor of said pre-existing vibrating tool is attached to said handle.

16. (canceled)

17. An apparatus for retro-fitting a tool handle of at least one of a pre-existing, vibrating, hand-held electric tool and a pre-existing, vibrating, hand-held, pneumatic tool in order to dampen vibration and make the tool more ergonomically useable comprising:
a grip comprising detachable and attachable left and right grip sides wherein each of the left and right grip sides is at least one of made of and lined with a vibration dampening material, and wherein said left and right grip sides collectively form an internal cavity when attached together for retro-fitting and enclosing a portion of the handle of said at least one pre-existing. vibrating, hand-held electric tool, and said pre-existing, vibrating, hand-held, pneumatic tool.

18. (canceled)

19. The apparatus of claim 17 wherein said grip is adapted to substantially enclose the entire pre-existing, vibrating tool within the internal cavity of said left and right grips sides.

20. The apparatus of claim 17 wherein said internal cavity is adapted to enclose a handle portion of the pre-existing, vibrating tool which is wrapped with a second vibration dampening material.

21. The apparatus of claim 17 wherein said grip is sized so that said grip is at least one of a same size and smaller than a handle of an original, non-retrofitted vibrating tool.

22. The apparatus of claim 17 wherein said grip is a right angle grip which is adapted to substantially enclose a fight angle, pre-existing, vibrating tool within the intefior cavity of the left and fight grips.

23. (canceled)

24. A retro-fitted, hand-held, vibrating tool which is pneumatic or electric, wherein a handle portion of said retro-fitted vibrating tool was retro-fitted in order to be substantially enclosed within an internal cavity of detachable and attachable left and fight grip sides of a grip which is at least one of made of and lined with a vibration dampening matefial, wherein the grip dampens vibration and makes the tool more ergonomically useable.

25. (canceled)

26. The tool of claim 24 wherein said handle portion of said retro-fitted, vibrating tool was wrapped with a second dampening material which is substantially enclosed within said internal cavity of said grip.

27. The tool of claim 24 wherein said retro-fitted, vibrating tool is a right angle tool and said grip is a right angle grip.

28. The tool of claim 24 wherein said handle portion of said retro-fitted, vibrating tool was reduced in size relative to a handle portion of an original, nonretro-fitted, vibrating tool was reduced in size relative to a handle of an original, nonretrofitted, vibrating tool.

29. The tool of claim 28 wherein said grip is at least one of a same size and smaller than said handle portion of said original, non-retrofitted, vibrating tool.
